(19) United States
(12) Patent Application Publication
(10) Pub. No.: US 2011/0186195 A1
(43) Pub. Date: Aug. 4, 2011

(54) WALLET CARD INSERT IDENTIFICATION SYSTEM

(76) Inventor: Pamela S. Cohen, Wendell, NC (US)

(21) Appl. No.: 12/699,481

(22) Filed: Feb. 3, 2010

(51) Int. Cl. A45C 1/06; B42F 21/00

(52) U.S. Cl. 150/139; 283/37

(57) ABSTRACT

The present invention relates to a wallet card insert which further comprises a tab on each sleeve. The tab system allows one with many sleeves in their wallet to find particular cards, IDs, photos, and the like without undue searching effort.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a wallet insert for holding cards. In particular, the present invention relates to a wallet insert to which ID tabs have been added to easily identify and find particular cards in the wallet.

2. Description of Related Art

Men's wallets for holding money tend to be relatively small double or triple fold construction designed to place in a pants pocket. Other wallet designs, including most women's wallets and some men's wallets, are sized to accept paper money in an unfolded state. Accordingly, most wallets are approximately no bigger than about 7 and a half inches long, but many are only 5 to 6 inches in length.

For the last several decades, manufacturers have produced wallet card inserts. A wallet card insert is designed to hold pictures, credit cards, ID cards, driver's license, and the like. A quick check on the internet reveals that there are literally hundreds of different models of these inserts available. They are all made of clear or essentially clear plastic, so that the contents can be viewed easily. While there are hundreds of models of these inserts, they all comprise several plastic sleeves, and a means for inserting in the wallet usually some sort of pocket insert portion. While having a wallet with various types of cards is useful, a problem that has existed for decades, is finding a particular card when several are present. Since the introduction of plastic wallet card inserts, the only means for finding a particular card in the card insert is to page through the sleeves of the insert one at a time till the desired card is located.

### BRIEF SUMMARY OF THE INVENTION

It has been discovered that a decades old problem can be solved by having an identification tab on the top or side of each sleeve, identifying the contents of the sleeve, making finding a particular card easy.

Accordingly, in one embodiment of the present invention, there is disclosed a wallet card insert for insertion in a wallet comprising a plurality of card holding sleeves, each sleeve having an identification tab positioned on the side or top of the sleeve.

In yet another embodiment of the present invention, there is a wallet having positioned therein a wallet card insert having a plurality of card holding sleeves, each sleeve having an identification tab positioned on the side or top of the sleeve.

### BRIEF DESCRIPTION OF THE DRAWINGS

FIG. 1 is a perspective view of a wallet card insert.

FIG. 2 is a perspective view of a wallet card insert in a wallet.

FIG. 3 is a front view of a wallet card insert.

### DETAILED DESCRIPTION OF THE INVENTION

While this invention is susceptible to embodiment in many different forms, there is shown in the drawings, and will herein, be described in detail specific embodiments, with the understanding that the present disclosure of such embodiments is to be considered as an example of the principles, and not intended to limit the invention to the specific embodiments shown and described. In the description below, like reference numerals are used to describe the same, similar, or corresponding parts in the several views of the drawings. This detailed description defines the meaning of the terms used herein, and specifically describes embodiments in order for those skilled in the art to practice the invention.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein a “wallet” refers to a small leather, fabric, or the like pocket, or purse sized case for holding paper money. They can be of the folding type, or can be the type to keep paper money flat. They are of a relatively small size unless folded smaller. In general, they are large enough to hold credit cards and driver's license, e.g., about 4 to 8 inches in length. Typically, they have some flap, either from the folding or otherwise to hold a wallet card insert. As used herein a “wallet card insert” is a collection of plastic sleeves for containing cards, such as credit cards, ID cards, photos, and the like. The individual plastic sleeve itself may be further subdivided to accommodate key ring size or other size cards. The plastic sleeves are characterized by being relatively small (credit card sized) clear, and having a means for holding cards in place in the wallet. Such holding means is usually a flap which slips into a pocket in the wallet. When positioned in a wallet, a wallet card insert presents a plurality of sleeves which hold these important cards for viewing or use.

As used herein an “identification tab” is an addition to each of the wallet card inserts that protrudes from the top or side of the sleeve to identify the contents of the individual sleeve. The tab could be blank for writing or otherwise indicating the content, could be numbered, or lettered, or the like to make them smaller, however, choice of writable or not is within the skill in the art. It should be noted once again that in the past decades where such sleeves for wallets have been available, no indexing system has been available to find items in wallet card inserts. In light of the hundreds of inserts that are available until the present invention, no means has been introduced to help with the problem of finding a particular card in the wallet.

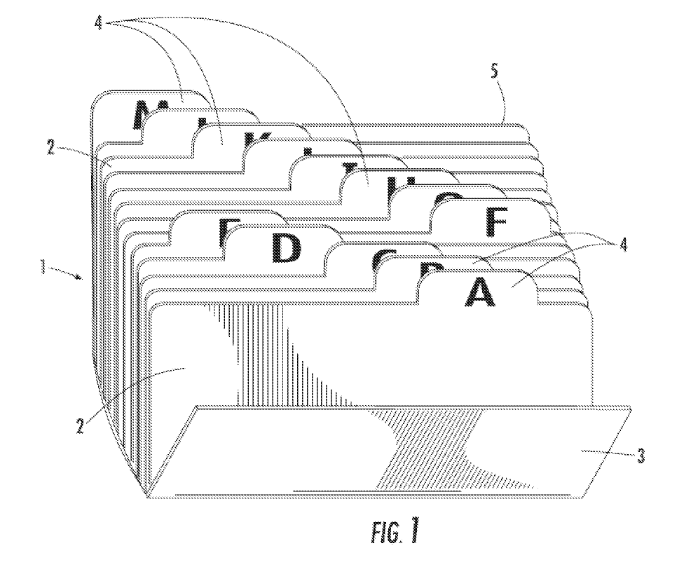

Now referring to the drawings, FIG. 1 is a perspective view of a wallet card insert 1 of the present invention. The wallet card insert comprises a plurality of card holding sleeves 2 with a flap 3 for inserting in a wallet pocket for holding it in place. The present invention comprises identification tabs 4. In this embodiment, the tabs 4 are lettered, but they could be numbered, or allow for writing on each of them. In this particular perspective, the tabs 4 are on the top portion 5 of the sleeves 2.

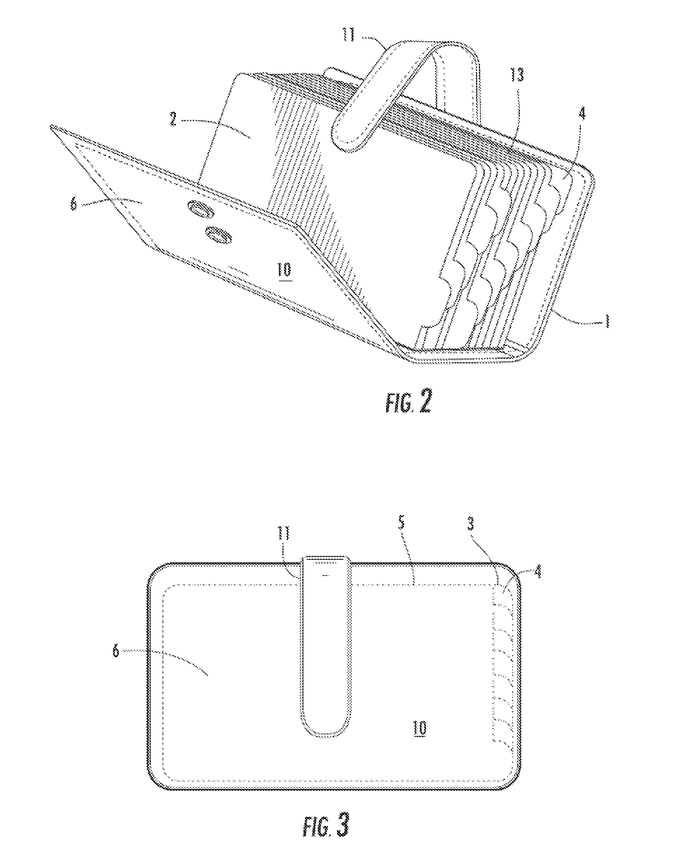

FIG. 2 is a perspective view of the wallet card insert in a wallet 6. In this view, the wallet 6 is a woman's style wallet with outer flap 10 and snap fastener 11. This perspective has the tabs 4 on the side 13 of the sleeves 2. FIG. 3 is a front view of a wallet 6 with the wallet card insert shown in dotted line perspective since it is hidden from view in this perspective. As noted, the wallet card insert and tabs needs to be sized such that the tabs and sleeves remain inside the wallet when closed.

It is clear that each embodiment is separate, however, a claim of the invention is not intending to be limiting, unless so noted by applicant. The entire invention can have other embodiments, and the like based on the teaching herein, and the claims should be read so encompassing, unless applicant is limiting the invention to specific embodiments herein.

1-2. (canceled)

3. A rectangular wallet having a width and a height which is hinged along the width of the wallet having positioned therein a rectangular wallet card insert having a length and width about the length and width of the wallet and having a plurality of card holding sleeves hinged together as a single unit on a width of the sleeves wherein the hinged sleeve width length is positioned in the wallet such that the respective hinged wallet and sleeve widths are along the same side and wherein each of the sleeves comprises an identification tab on the width that is not hinged or on one of the heights.
